(19) United States
(12) Patent Application Publication
(10) Pub. No.: US 2014/0139164 A1
(43) Pub. Date: May 22, 2014

(54) APPARATUS AND METHOD FOR CONTROLLING MOTOR DRIVING AND MOTOR USING THE SAME

(71) Applicant: SAMSUNG ELECTRO-MECHANICS CO., LTD., Suwon (KR)

(72) Inventor: Joo Yul KO, Gyunggi-do (KR)

(73) Assignee: SAMSUNG ELECTRO-MECHANICS CO., LTD., Suwon (KR)

(21) Appl. No.: 13/770,956

(22) Filed: Feb. 19, 2013

(30) Foreign Application Priority Data
Nov. 19, 2012 (KR) 10-2012-0130979

(51) Int. Cl. H02P 29/00

(52) U.S. Cl. CPC H02P 29/00
USPC 318/461; 318/490

(57) ABSTRACT

There are provided an apparatus and a method for controlling motor driving and a motor using the same. The motor driving control apparatus according to an embodiment of the present invention includes a driving signal generating unit generating a driving signal for a motor apparatus; a speed detecting unit detecting a rotational speed of the motor apparatus; and a controlling unit monitoring an instantaneous speed and an average speed using the rotational speed and comparing the instantaneous speed with the average speed to determine an occurrence of an abnormal state in the motor apparatus.

### CROSS-REFERENCE TO RELATED APPLICATIONS

This application claims the priority of Korean Patent Application No. 10-2012-0130979 filed on Nov. 19, 2012, in the Korean Intellectual Property Office, the disclosure of which is incorporated herein by reference.

### BACKGROUND OF THE INVENTION

1. Field of the Invention

The present invention relates to an apparatus and a method for controlling motor driving capable of rapidly sensing an abnormal motor state by determining the occurrence of an abnormal state in the motor apparatus through determining whether or not a driving signal for the motor has changed and using a difference between an average speed and a current speed of the motor, and a motor using the same.

2. Description of the Related Art

In accordance with the continuing development of motor technology, motors having various sizes have been used in various technological fields.

In general, a motor is driven by rotating a rotor using a permanent magnet and a coil in which the polarity thereof is changed according to current applied thereto. Early motors had the form of brush type motors in which a rotor included a coil, but had a problem such as wear of a brush or the generation of sparks due to driving of the motor. Therefore, recently, brushless motors having various forms have generally been used. A brushless motor uses a permanent magnet as a rotor and has a stator including a plurality of coils so as to rotate the rotor.

In the case of the above-mentioned brushless motor, foreign objects may be introduced thereto from the outside, according to the rotation of the motor and control errors may occur in the case in which foreign objects are introduced thereto.

For example, in the case of a fan motor, when the motor is covered or clogged with dust, pressure of a motor blade may be changed. Therefore, the speed of the fan motor may not be controlled as desired, but may be variably changed by an external effect, such that performance of the motor may be deteriorated or heating may occur.

The following Related Art Documents relate to the above-mentioned motor control, but fail to disclose a technology capable of checking the error caused due to the introduction of the foreign objects as described above.

### RELATED ART DOCUMENT

(Patent Document 1) Korean Patent Laid-Open Publication No. 2005-0035451
(Patent Document 2) Korean Patent Laid-Open Publication No. 2006-0054627

### SUMMARY OF THE INVENTION

An aspect of the present invention provides an apparatus and a method for controlling motor driving capable of rapidly sensing an abnormal motor state by determining the occurrence of an abnormal state in the motor apparatus through determining whether or not a driving signal for the motor has changed and using a difference between an average speed and a current speed of the motor, and a motor using the same.

According to an aspect of the present invention, there is provided a motor driving control apparatus, including: a driving signal generating unit generating a driving signal for a motor apparatus; a speed detecting unit detecting a rotational speed of the motor apparatus; and a controlling unit monitoring an instantaneous speed and an average speed using the rotational speed and comparing the instantaneous speed with the average speed to determine an occurrence of an abnormal state in the motor apparatus.

The controlling unit may determine that the abnormal state has not occurred, independent of a difference between the instantaneous speed and the average speed when a value of the driving signal has changed.

The controlling unit may include: an average speed calculator calculating the average speed using the rotational speed provided by the speed detecting unit; and a signal generator generating an abnormal state signal for the motor apparatus when the instantaneous speed deviates from a preset error range for the average speed.

The controlling unit may further include a driving signal monitor monitoring whether or not a value of the driving signal provided by the driving signal generating unit has changed and generating a speed command signal indicating whether or not a driving speed of the motor apparatus has changed.

The signal generator may determine whether or not the abnormal state signal is generated when the signal generator receives the speed command signal from the driving signal monitor, the speed command signal indicating that the value of the driving signal is maintained.

The speed command signal may include a first value and a second value different from each other. The first value may correspond to a state in which the value of the driving signal is maintained within a predetermined range, and the second value may correspond to a state in which the value of the driving signal has changed.

The signal generator may monitor whether or not the instantaneous speed deviates from the preset error range for the average speed while receiving the first value from the driving signal monitor, and generate the abnormal state signal having an ON value when the instantaneous speed deviates from the preset error range.

The average speed calculator may include: a memory collecting a plurality of rotational speeds provided by the speed detecting unit at predetermined intervals of time and storing the collected rotational speeds; and an average calculator calculating an average of the plurality of rotational speeds stored in the memory.

According to another aspect of the present invention, there is provided a motor, including: a motor apparatus performing an operation according to a driving signal; and a motor driving control apparatus providing the driving signal to the motor apparatus to control a driving of the motor apparatus and determining an occurrence of an abnormal state in the motor apparatus.

The motor driving control apparatus may include: a driving signal generating unit generating the driving signal for the motor apparatus; a speed detecting unit detecting a rotational speed of the motor apparatus; and a controlling unit monitoring an instantaneous speed and an average speed using the rotational speed and comparing the instantaneous speed with the average speed to determine the occurrence of the abnormal state in the motor apparatus.

The motor driving control apparatus may determine that the abnormal state has not occurred, independent of a difference between the instantaneous speed and the average speed when a value of the driving signal has changed.

According to another aspect of the present invention, there is provided a method of controlling motor driving performed by a motor driving control apparatus controlling driving of a motor apparatus, the method including: monitoring an instantaneous speed and an average speed of the motor apparatus; and comparing the instantaneous speed with the average speed and generating an abnormal state signal for the motor apparatus when the instantaneous speed deviates from a preset error range with respect to the average speed.

The monitoring of the instantaneous speed and the average speed may include: detecting a rotational speed of the motor apparatus; and calculating the average speed by monitoring the rotational speed during a predetermined time.

The generating of the abnormal state signal may include allowing the abnormal state signal not to be generated when a driving signal for the motor apparatus has changed, even in the case that the instantaneous speed deviates from the preset error range.

The method may further include decreasing a duty ratio of a driving signal or stopping the driving of the motor apparatus when the abnormal state signal is generated.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating an example of a general motor driving apparatus;

FIG. 2 is a configuration diagram illustrating a motor driving apparatus according to an embodiment of the present invention;

FIG. 3 is a detailed configuration diagram illustrating a controlling unit according to the embodiment of the present invention;

FIG. 4 is a circuit configuration diagram illustrating a detailed example of a signal generator according to the embodiment of the present invention;

FIG. 5 is a signal graph illustrating an operation of the signal generator according to the embodiment of the present invention; and

FIG. 6 is a flowchart illustrating a method of controlling motor driving according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like components.

Hereinafter, the present invention will be described based on a brushless motor for convenience of explanation. However, the present invention is not limited to the brushless motor.

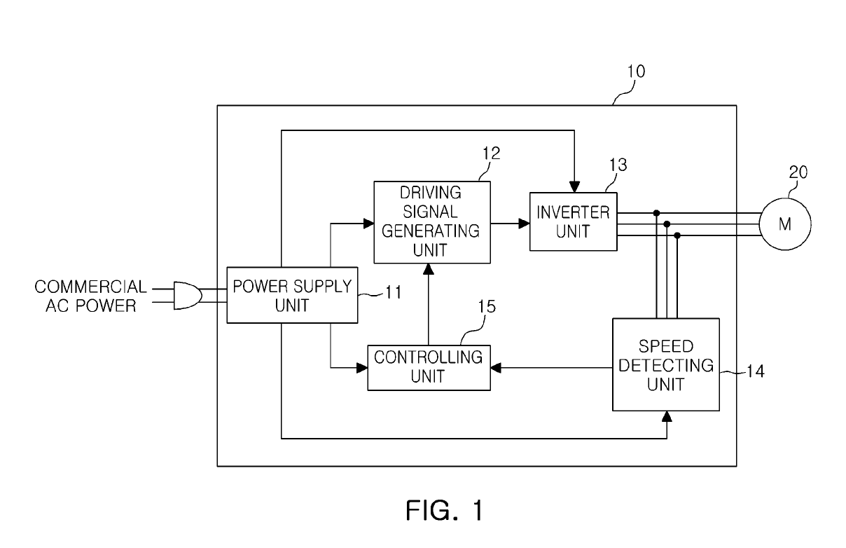

FIG. 1 is a configuration diagram illustrating an example of a general motor driving control apparatus.

Referring to FIG. 1, a motor driving control apparatus 10 may include a power supply unit 11, a driving signal generating unit 12, an inverter unit 13, a speed detecting unit 14, and a controlling unit 15.

The power supply unit 11 may supply power to individual components of the motor driving control apparatus 10. For example, the power supply unit 11 may convert commercial alternating current (AC) voltage into direct current (DC) voltage and supply the converted DC power.

The driving signal generating unit 12 may provide a driving signal to the inverter unit 13. In the embodiment, the driving signal may be a pulse width modulation (PWM) signal.

The inverter unit 13 may control an operation of a motor apparatus 20. For example, the inverter unit 13 may convert the DC voltage into a plurality of phase (for example, three-phase through four-phase) voltages according to the driving signal to apply the converted phase voltages to coils (not shown) of the motor apparatus 20, respectively. A current flowing in each phase generates a magnetic field in each coil and the magnetic field may rotate a rotor (not shown) included in the motor apparatus 20.

The speed detecting unit 14 may detect a rotational speed of the motor apparatus. The speed detecting unit 14 may be implemented as various speed detecting units. As an example, the speed detecting unit 14 may be implemented as a hall sensor. As another example, the speed may be detected using back electromotive force generated from the motor apparatus 20.

The controlling unit 15 may control the driving signal generating unit 12 so that the driving signal generating unit 12 generates the driving signal by reflecting the speed provided by the speed detecting unit 14, speed requested by external input, and the like.

However, as described above, the above-mentioned motor driving control apparatus 10 has a limitation in that the speed control may be inaccurately performed when the motor apparatus 20 is clogged with foreign objects.

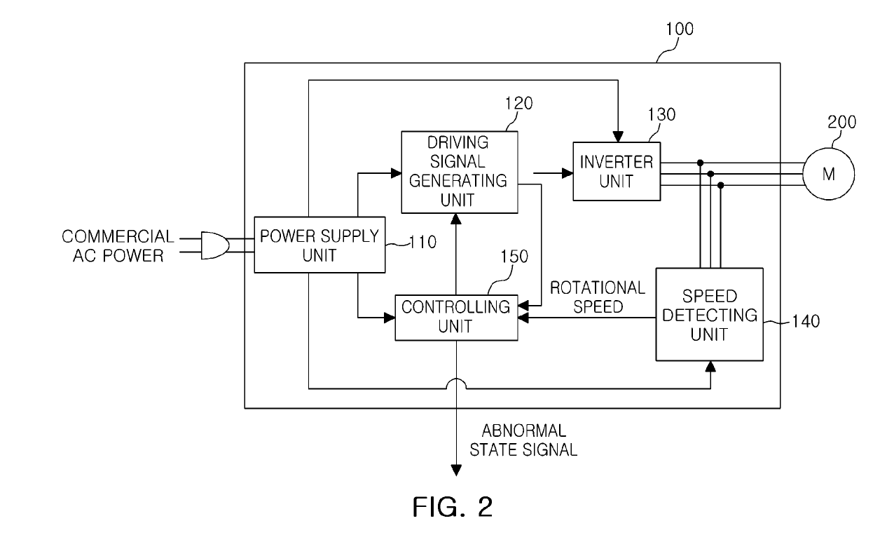

Hereinafter, various embodiments of the present invention will be described with reference to FIGS. 2 through 6.

In descriptions of the embodiments of the present invention to be described below, overlapped descriptions of contents which are equal to or correspond to the contents described above with reference to FIG. 1 will be omitted. However, those skilled in the art may clearly understand the detailed contents of the present invention from the above descriptions.

FIG. 2 is a configuration view illustrating a motor driving control apparatus according to an embodiment of the present invention.

Referring to FIG. 2, a motor driving control apparatus 100 may include a power supply unit 110, a driving signal generating unit 120, an inverter unit 130, a speed detecting unit 140, and a controlling unit 150.

The power supply unit 110 may supply power to respective components of the motor driving control apparatus 100.

The driving signal generating unit 120 may generate a driving signal for a motor. For example, the driving signal generating unit 120 may generate a pulse width modulation signal (hereinafter, referred to as a PWM signal) having a predetermined duty ratio and provide the PWM signal to the inverter unit 130.

The inverter unit 130 may receive the driving signal to drive each phase of a motor apparatus 200.

The speed detecting unit 140 may detect a rotational speed of the motor apparatus 200.

The controlling unit 150 may determine whether or not an abnormal state has occurred in the motor apparatus 200 based on the rotational speed.

More specifically, the controlling unit 150 may monitor an instantaneous speed and an average speed using the rotational speed. The controlling unit 150 may compare the instantaneous speed with the average speed to determine whether or not the abnormal state has occurred in the motor apparatus 200.

In the embodiment of the present invention, the controlling unit 150 may further reflect whether or not the driving signal has changed to determine whether or not the abnormal state has occurred in the motor apparatus 200.

More specifically, the controlling unit 150 may receive the driving signal from the driving signal generating unit 120 to determine whether or not a value of the driving signal has changed. In the case in which the value of the driving signal has changed, the controlling unit 150 may determine that the abnormal state has not occurred, independent of whether or not there is a difference between the instantaneous speed and the average speed.

In the embodiment of the present invention, the controlling unit 150 may provide an abnormal state signal to the outside. The abnormal state signal provided to the outside may be used to provide information that the abnormal state in the motor apparatus 200 has occurred using a separate component.

In the embodiment of the present invention, when the abnormal state signal is generated, the controlling unit 150 may perform a preset operation under the condition that the abnormal state signal is generated. For example, after the abnormal state signal is generated, the controlling unit 150 may control the driving signal generating unit 120 to decrease the duty ratio of the driving signal. In another example, after the abnormal state signal is generated, the controlling unit 150 may control the driving signal generating unit 200 to stop the driving of the motor apparatus 200.

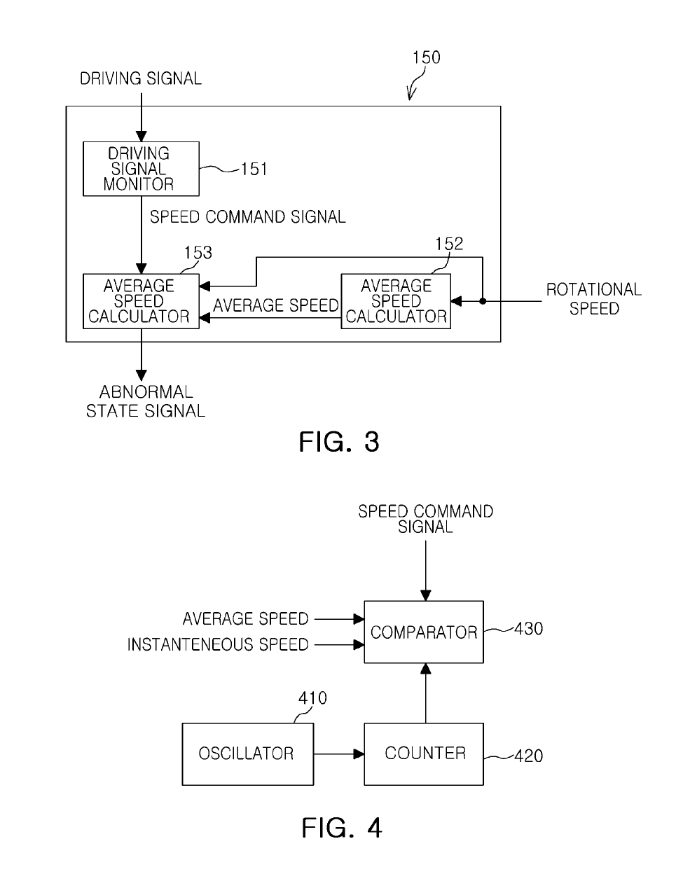

Hereinafter, a detailed configuration of the above-mentioned controlling unit 150 will be described in more detail with reference to FIGS. 3 through 5.

FIG. 3 is a detailed configuration diagram illustrating a controlling unit according to the embodiment of the present invention.

Referring to FIGS. 2 and 3, the controlling unit 150 may include an average speed calculator 152 and a signal generator 153. In the embodiment of the present invention, the controlling unit 150 may further include a driving signal monitor 151.

The average speed calculator 152 may calculate the average speed using the rotational speed provided by the speed detecting unit 140.

In the embodiment of the present invention, the average speed calculator 152 may be configured of a memory (not shown) and an average calculator (not shown). More specifically, the memory may collect the rotational speed provided by the speed detecting unit 140 at predetermined intervals of time and store the collected rotational speeds. The average speed calculator may calculate an average of the plurality of rotational speeds stored in the memory. The memory and the average speed calculator may have various configurations and the detailed configurations thereof are not specifically limited.

The signal generator 153 may determine whether or not the abnormal state has occurred in the motor apparatus 200 using the instantaneous speed and the average speed and generate the abnormal state signal in the case in which it is determined that the abnormal state has occurred.

In the embodiment of the present invention, the signal generator 153 may determine that the abnormal state has occurred in the case in which the current instantaneous speed deviates from a range of the average speed. More specifically, the signal generator 153 may determine the instantaneous speed using the rotational speed provided by the speed detecting unit 140 and compare the determined instantaneous speed with the average speed stored in the average speed calculator 152. In the case in which the instantaneous speed deviates from a preset error range for the average speed, the signal generator 153 may determine that the abnormal state has occurred in the motor apparatus 200 and generate the abnormal state signal.

The driving signal monitor 151 may monitor whether or not the value of the driving signal provided by the driving signal generating unit 120 has changed and generate a speed command signal indicating whether or not the driving speed of the motor apparatus 200 has changed using the monitoring result. Therefore, the speed command signal may indicate a change in the driving signal (for example, a change in the duty ratio of the PWM signal) provided by the driving signal generating unit 120.

In the embodiment of the present invention, the speed command signal may be represented by a first value and a second value different from each other. Here, the first value may correspond to a state in which the value of the driving signal is maintained within a predetermined range, and the second value may correspond to a state in which the value of the driving signal has changed. For example, the speed command signal may be indicated by a digital pulse waveform, and may have an OFF value in the case in which the value of the driving signal is maintained within a predetermined range and have an ON value in the case in which the value of the driving signal deviates from a predetermined range.

The speed command signal may be used as a signal determining whether speed control of the motor apparatus 200 has changed. That is, the signal generator 153 compares the instantaneous speed with the average speed to determine the occurrence of the abnormal state; however, in the case in which the speed of the motor apparatus 200 has changed, it should not be determined as the abnormal state.

Therefore, as a result of the monitoring of the speed command signal, in the case in which the value of the driving signal is maintained, the signal generator 153 may compare the instantaneous speed with the average speed to determine whether or not the abnormal state signal has occurred, as described above.

Meanwhile, as a result of the monitoring of the speed command signal, in the case in which the value of the driving signal has changed, the difference between the average speed and the instantaneous speed naturally occurs. Therefore, in this case, the signal generator 153 may not generate the abnormal state signal.

Therefore, in the embodiment of the present invention in which the speed command signal is represented by the first value and the second value different from each other, the signal generator 153 may determine whether or not the instantaneous speed deviates from the preset error range for the average speed when the first value is received from the driving signal monitor 151 and generate the abnormal state signal having the ON value in the case in which the instantaneous speed deviates from the preset error range.

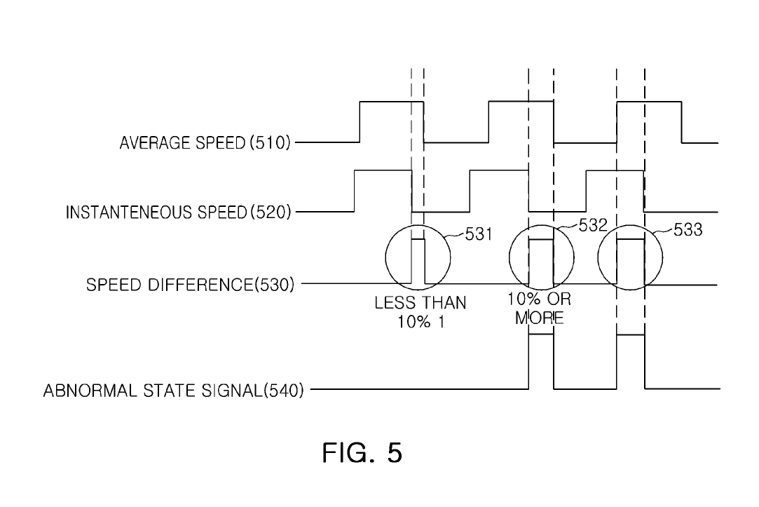

FIG. 4 is a circuit configuration diagram illustrating a detailed example of the signal generator 153 shown in FIG. 3, and FIG. 5 is a signal graph illustrating an operation of the signal generator 153 shown in FIG. 3.

Referring to FIGS. 3 through 5, the signal generator 153 may be configured of an oscillator 410, a counter 420, and a comparator 430.

The oscillator 410 may generate a predetermined signal waveform and provide the predetermined signal waveform to the counter 420, and the counter 420 may generate unit time from the signal waveform and provide the unit time to the comparator 430.

The comparator 430 may compare an average speed 510 with an instantaneous speed 520 based on the unit time and monitor a speed difference 530 between the average speed 510 and the instantaneous speed 520. In the case in which the speed difference 530 deviates from a preset error range, the comparator 430 may generate the abnormal state signal.

In the illustrated example, the preset error range is 10%. In the case in which the error of the PWM signal is generated within 1%, the error of the speed is generally generated within an error range of 10%. Therefore, in this example, in the case in which the error of the PWM signal is generated within 1%, it is determined that the abnormal state has not occurred, whereas in the case in which the error of the PWM signal deviates from the error range, it is determined that the abnormal state has occurred. However, since these numerical values are only an example, the present invention is not limited thereto.

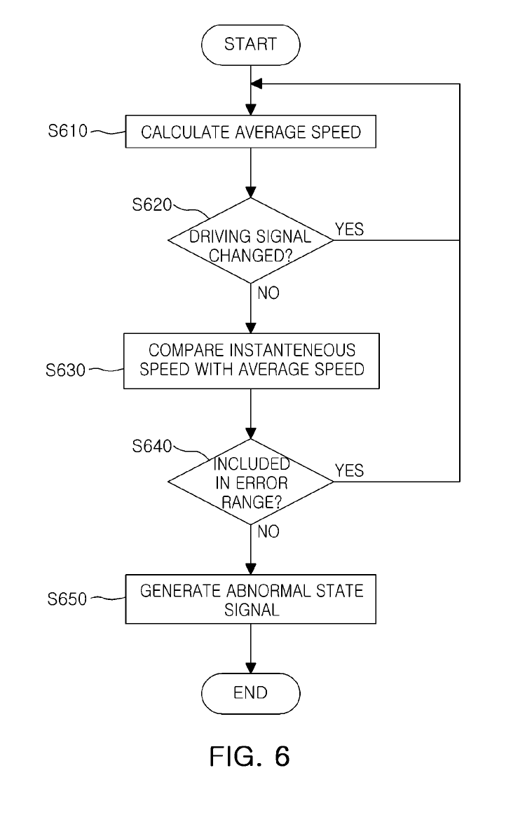

FIG. 6 is a flowchart illustrating a method of controlling motor driving according to an embodiment of the present invention.

Hereinafter, a method of controlling motor driving according to an embodiment of the present invention will be described with reference to FIG. 6. Since the method of controlling motor driving according to the embodiment of the present invention is performed by the motor driving control apparatus 100 described above with reference to FIGS. 2 through 5, an overlapped description will be omitted.

Referring to FIG. 6, the motor driving control apparatus 100 may calculate an average speed (S610). The motor driving control apparatus 100 may re-calculate the average speed per a predetermined period and update the re-calculated average speed. In the case in which a change in a driving signal for the motor apparatus 200 is not detected (S620, NO), the motor driving control apparatus 100 may monitor an instantaneous speed and the average speed of the motor apparatus 200 and compare the instantaneous speed with the average speed (S630).

In the case in which the instantaneous speed is not included within a preset error range with respect to the average speed (S640, NO), the motor driving control apparatus 100 may generate an abnormal state signal for the motor apparatus 200 (S650).

In operation S630, the motor driving control apparatus 100 may detect the rotational speed of the motor apparatus 200 and monitor the rotational speed during a predetermined time to calculate the average speed.

In operation S650, when the driving signal for the motor apparatus 200 has changed, the motor driving control apparatus 100 may not generate the abnormal state signal even in the case that the instantaneous speed deviates from the preset error range. This is intended not to be determined as the abnormal state in the case in which the speed change is generated by the driving control of the motor apparatus 200.

In the embodiment of the present invention, the motor driving control apparatus 100 may perform a preset control operation in the case in which the abnormal state has occurred. More specifically, the motor driving control apparatus 100 may decrease the duty ratio of the driving signal or stop the driving of the motor apparatus when the abnormal signal has occurred.

As set forth above, according to embodiments of the invention, the occurrence of an abnormal state in a motor is determined through determining whether or not a driving signal for the motor has changed and using a difference between an average speed and a current speed of the motor, whereby the abnormal state in the motor may be rapidly detected. In addition, when the abnormal state occurs, the speed of the motor is decreased to thereby rapidly deal with the abnormal state.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus, comprising:
a driving signal generating unit generating a driving signal for a motor apparatus;
a speed detecting unit detecting a rotational speed of the motor apparatus; and
a controlling unit monitoring an instantaneous speed and an average speed using the rotational speed and comparing the instantaneous speed with the average speed to determine an occurrence of an abnormal state in the motor apparatus.

2. The motor driving control apparatus of claim 1, wherein the controlling unit determines that the abnormal state has not occurred, independent of a difference between the instantaneous speed and the average speed when a value of the driving signal has changed.

3. The motor driving control apparatus of claim 1, wherein the controlling unit includes:
an average speed calculator calculating the average speed using the rotational speed provided by the speed detecting unit; and
a signal generator generating an abnormal state signal for the motor apparatus when the instantaneous speed deviates from a preset error range for the average speed.

4. The motor driving control apparatus of claim 3, wherein the controlling unit further includes a driving signal monitor monitoring whether or not a value of the driving signal provided by the driving signal generating unit has changed and generating a speed command signal indicating whether or not a driving speed of the motor apparatus has changed.

5. The motor driving control apparatus of claim 4, wherein the signal generator determines whether or not the abnormal state signal is generated when the signal generator receives the speed command signal from the driving signal monitor, the speed command signal indicating that the value of the driving signal is maintained.

6. The motor driving control apparatus of claim 4, wherein the speed command signal includes a first value and a second value different from each other,
the first value corresponds to a state in which the value of the driving signal is maintained within a predetermined range, and
the second value corresponds to a state in which the value of the driving signal has changed.

7. The motor driving control apparatus of claim 6, wherein the signal generator monitors whether or not the instantaneous speed deviates from the preset error range for the average speed while receiving the first value from the driving signal monitor, and generates the abnormal state signal having an ON value when the instantaneous speed deviates from the preset error range.

8. The motor driving control apparatus of claim 3, wherein the average speed calculator includes:
a memory collecting a plurality of rotational speeds provided by the speed detecting unit at predetermined intervals of time and storing the collected rotational speeds; and
an average calculator calculating an average of the plurality of rotational speeds stored in the memory.

9. A motor, comprising:
a motor apparatus performing an operation according to a driving signal; and
a motor driving control apparatus providing the driving signal to the motor apparatus to control driving of the motor apparatus and determining an occurrence of an abnormal state in the motor apparatus.

10. The motor of claim 9, wherein the motor driving control apparatus includes:
a driving signal generating unit generating the driving signal for the motor apparatus;
a speed detecting unit detecting a rotational speed of the motor apparatus; and
a controlling unit monitoring an instantaneous speed and an average speed using the rotational speed and comparing the instantaneous speed with the average speed to determine the occurrence of the abnormal state in the motor apparatus.

11. The motor of claim 9, wherein the motor driving control apparatus determines that the abnormal state has not occurred, independent of a difference between the instantaneous speed and the average speed when a value of the driving signal has changed.

12. A method of controlling motor driving performed by a motor driving control apparatus controlling driving of a motor apparatus, the method comprising:
monitoring an instantaneous speed and an average speed of the motor apparatus; and
comparing the instantaneous speed with the average speed and generating an abnormal state signal for the motor apparatus when the instantaneous speed deviates from a preset error range with respect to the average speed.

13. The method of claim 12, wherein the monitoring of the instantaneous speed and the average speed includes:
detecting a rotational speed of the motor apparatus; and
calculating the average speed by monitoring the rotational speed during a predetermined time.

14. The method of claim 12, wherein the generating of the abnormal state signal includes allowing the abnormal state signal not to be generated when a driving signal for the motor apparatus has changed, even in the case that the instantaneous speed deviates from the preset error range.

15. The method of claim 12, further comprising decreasing a duty ratio of a driving signal or stopping the driving of the motor apparatus when the abnormal state signal is generated.
